(19) United States
(12) Patent Application Publication
(10) Pub. No.: US 2012/0325397 A1
(43) Pub. Date: Dec. 27, 2012

(54) Conduit, Manufacture Thereof and Fusion Process Therefor

(75) Inventors: William F. Becker, Pittsburgh, PA (US); Thomas Marti, Mars, PA (US); Eric Kerner, Cocoa, FL (US); Michael Benvenuti, Tarentum, PA (US); Michael McKanna, Beaver Falls, PA (US); Douglas Urbanek, Tarentum, PA (US)

(73) Assignee: Underground Solutions Technologies Group, Inc., Poway, CA (US)

(21) Appl. No.: 13/603,931

(22) Filed: Sep. 5, 2012

Related U.S. Application Data
(63) Continuation of application No. 12/102,298, filed on Apr. 14, 2008.
(60) Provisional application No. 60/923,298, filed on Apr. 13, 2007.

(51) Int. Cl. B32B 37/02

(52) U.S. Cl. 156/158

(57) ABSTRACT

A method for fusing a first conduit to a second conduit. The first conduit and the second conduit each include a linear portion having a linear portion inside diameter, and at least one bell portion with a first end and a second end and having a bell portion inside diameter that increases from the first end to the second end. The method includes: melting at least a portion of each of the second end of the bell portion of the first conduit and the second end of the bell portion of the second conduit; and engaging the melted second end of the bell portion of the first conduit with the melted second end of the bell portion of the second conduit, thereby creating a fused joint area.

### CROSS REFERENCE TO RELATED APPLICATIONS

This application is a continuation application of U.S. patent application Ser. No. 12/102,298, filed Apr. 14, 2008, which is a non-provisional of U.S. Provisional Patent Application No. 60/923,298, filed Apr. 13, 2007, each of which is incorporated herein by reference in their entireties.

### BACKGROUND OF THE INVENTION

1. Field of the Invention

The present invention relates generally to systems for fusing or joining conduit or piping sections, such as polyvinyl chloride conduit or piping and, in particular, to a fusion process for effectively and permanently joining a first conduit to a second conduit.

2. Description of Related Art

Conduit systems are used in many applications throughout the world in order to transfer or convey material, such as water and other fluids, from location to location for distribution throughout the system. In addition, conduit systems are also utilized as a structural enclosure for communication wiring, power wiring, data wiring, fiber optic cable, etc. Typically, such conduit or piping systems are located underground, as aboveground piping would be both unsightly and intrusive.

Fusion processes for pipe or conduit have been developed that utilize mechanical joints, embedded wires at or near the fusion joint or resistive heating elements for joining conduit sections together. For example, see U.S. Pat. Nos. 6,398,264 to Bryant, III; 6,394,502 to Andersson; 6,156,144 to Lueghamer; 5,921,587 to Lueghamer; 4,684,789 to Eggleston; and 4,642,155 to Ramsey. Polyethylene pipe (PE or HDPE) has been routinely fused for many years. For example, see U.S. Pat. Nos. 3,002,871 to Tramm et al.; 4,987,018 to Dickinson et al.; 4,963,421 to Dickinson et al.; and 4,780,163 to Haneline, Jr. et al. and U.S. Patent Publication No. 2003/0080552 to Genoni. Accordingly, preexisting fusion equipment is available.

In addition, the fusion of polyvinyl chloride conduit is known and practiced, as described and claimed in U.S. Pat. No. 6,982,051 to St. Onge et al. The assignee and owner of this patent is identical to the assignee and owner of the present invention and application. Further and accordingly, the disclosure and contents of this patent are incorporated herein by reference.

One drawback associated with the prior art is the creation of an internal bead extending from the inner wall of fused pipe. Specifically, when pipe ends are fused together, and due to the heat required to melt and fuse the conduit, when the terminal ends of two pipe sections are melted and engaged, the engagement pressure results in the creation of a bead extending from both the internal wall and external wall of the now-fused pipe. The internal bead encroaches into the internal area of the fused pipe, interferes with the flow of liquid through the pipe, and reduces the internal cross section and path of the conduit. Further, the presence of such an internal bead may interfere with and impact certain objects inserted therein, e.g., communication, power and data wiring, etc. For example, the bead may damage the insulation layer of the wire, which may detrimentally affect the wire signal, or cause short circuits in the line.

Presently, this internal bead is removed in a variety of manners. In one variation, the internal bead is removed with a manual or mechanical tool or arrangement. However, such manual/mechanical removal may not result in a complete removal of the bead, and the cost of removing the bead (in terms of both time and expense) is often high. Still further, in many instances this bead removal step is simply forgotten during the installation process. In another variation, as opposed to using fused pipe, certain mechanical arrangements are used to connect pipe segments. For example, handhole boxes may be used, but such use leads to additional “joints” in the conduit, which results in more potential “leak” points, and are otherwise limited to the coiled pipe length. Still further, using mechanical joints normally leads to corrosion and other degradation over a period of time, which again increases maintenance and associated costs. In addition, mechanical joints may not be used in many specialized applications, e.g., trenchless applications, as well as applications that require high joint strength.

### SUMMARY OF THE INVENTION

It is, therefore, an object of the present invention to provide a fusion process for conduit that overcomes the deficiencies of the prior art. It is another object of the present invention to provide a fusion process for conduit that allows for the onsite connection of multiple lengths of conduit. It is a further object of the present invention to provide a fusion process for conduit that provides a single piece of starting stock with no mechanical joints, which precludes infiltration through these joints. It is another object of the present invention to provide a shaped and fusible thermoplastic conduit that may be fused and used in a variety of applications. It is a still further object of the present invention to provide a method of fusing shaped conduit. It is another object of the present invention to provide a method of manufacturing shaped conduit.

The present invention is directed to a method for fusing a first conduit to a second conduit. The first conduit and the second conduit each include a linear portion having a linear portion inside diameter, and at least one bell portion with a first end and a second end and having a bell portion inside diameter that increases from the first end to the second end. The method includes: (a) melting at least a portion of each of the second end of the bell portion of the first conduit and the second end of the bell portion of the second conduit; and (b) engaging the melted second end of the bell portion of the first conduit with the melted second end of the bell portion of the second conduit, thereby creating a fused joint area.

In a further aspect, the present invention is directed to a method of forming a conduit. This method includes engaging a terminal end of a linear section of the conduit with a shaped mandrel, thereby forming a bell portion at the terminal end of the conduit. The bell portion includes a first end and a second end and has a bell portion inside diameter that increases from the first end to the second end.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a side sectional view of one embodiment of a conduit according to the present invention;

FIG. 2 is a side view of another embodiment of a conduit according to the present invention;

FIG. 3 is a side sectional view of a fused conduit made in accordance with the method of the present invention;

FIG. 4 is a side sectional view of a conduit in an intermediate step of manufacture in one embodiment of the present invention; and

FIG. 5 is a side sectional view of a conduit in an intermediate step of manufacture in another embodiment of the present invention.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

Various numerical ranges are disclosed in this patent application. Because these ranges are continuous, they include every value between the minimum and maximum values. Unless expressly indicated otherwise, the various numerical ranges specified in this application are approximations.

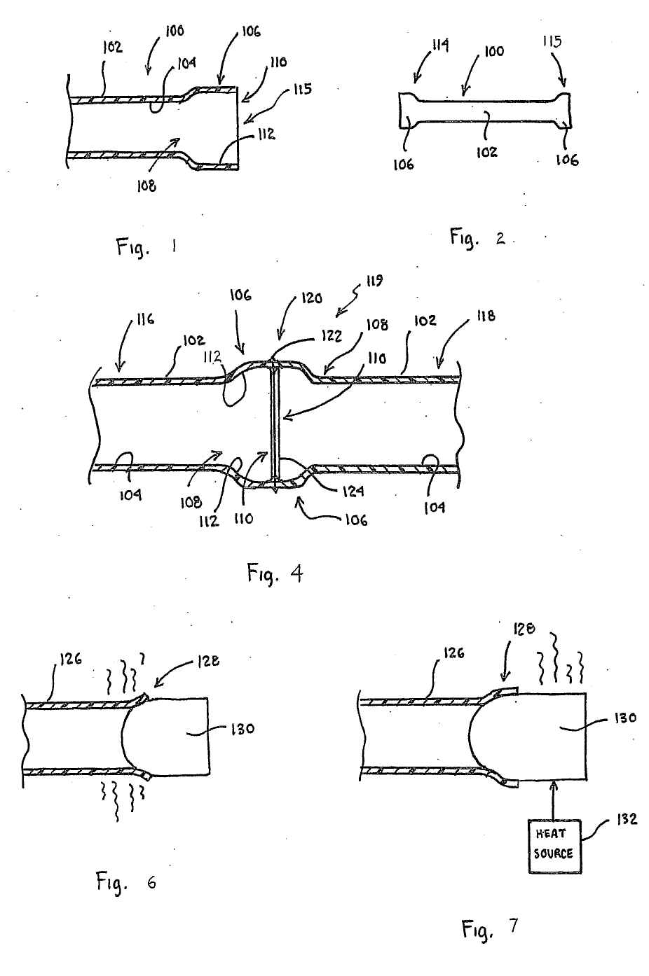

In one aspect of the present invention, and as illustrated in various embodiments in FIGS. 1-5, a conduit 100 is provided. As best seen in FIG. 1, the conduit 100 includes a linear portion 102 having a linear portion inside diameter 104. In addition, the conduit 100 includes at least one bell portion 106 having a first end 108 and a second end 110. The bell portion 106 has a bell portion inside diameter 112, and this diameter 112 increases from the first end 108 of the bell portion 106 to the second end 110 of the bell portion 106. It is this changing inside diameter 112 that evidences the “bell” shape of the bell portion 106 of the conduit 100. While only illustrated on one end 114 of the conduit 100 in FIG. 1, it is envisioned that the bell portion 106 may be formed or positioned on either end 114 of the conduit 100. Such an arrangement is illustrated in FIG. 2. In addition, by placing the bell portion 106 on each end 114 of the conduit 100, multiple lengths of such conduit 100 may be fused together, as discussed in detail hereinafter.

As discussed above, and in one preferred and non-limiting embodiment, the conduit 100 and/or its components, namely the linear portion 102 and the bell portion 106 are manufactured from a polyvinyl chloride composition. In particular, the conduit 100 and/or any portion 102, 106 of the conduit 100 may be manufactured by extruding a polyvinyl chloride composition. Any number of compositions may be used in order to maximize the ability to successfully fuse sections of conduit 100 together.

In another aspect, the present invention is directed to a method for fusing a first conduit 116 to a second conduit 118. As discussed above, each conduit 116, 118 includes the linear portion 102 and at least one bell portion 106. The first conduit 116 and the second conduit 118 are fused as follows. First, the second end 110 of the bell portion 106 of the first conduit 116 is positioned in an opposing relationship with the second end 110 of the bell portion 106 of the second conduit 118. Next, the second ends 110 of the bell portions 106 of each conduit 116, 118 are aligned. At least a portion of the second ends 110 of each of the bell portions 106 of the conduits 116, 118 are melted. Further, the melted ends 110 are engaged with each other, and pressure is maintained between the engaged ends 110, thereby creating a fused joint area 120. In particular, the pressure and engagement of the melted ends 110 is maintained until the melted ends 110 of each conduit 100 are cooled sufficiently to provide a fused joint area 120 of a desired strength.

As discussed above, and in one preferred and non-limiting embodiment, the first conduit 116, the second conduit 118, the linear portion 102 of the first conduit 116, the linear portion 102 of the second conduit 118, the bell portion 106 of the first conduit 116 and/or the bell portion 106 of the second conduit 118 may be manufactured from a polyvinyl chloride composition. However, the first conduit 116 and the second conduit 118 may be extruded from a variety of thermoplastic materials, e.g., polyethylene, HDPE, etc. In addition, and as discussed above in connection with FIG. 1, one or both of the first conduit 116 and the second conduit 118 may include a bell portion 106 positioned or formed on both ends 114 of the conduit 116, 118. Accordingly, the first conduit 116 and the second conduit 118 are fused together at the second end 110 of the respective bell portion 106 of each conduit 116, 118.

In order to fuse additional lengths of conduit, the process may be used with subsequent pieces of conduit 100 having the bell portion 106. Specifically, the positioning, aligning, melting, engaging and pressurizing steps discussed above can be used to continue adding subsequent lengths of conduit 100, thereby forming a pipeline. It should be noted, however, that the fusion process described above only necessarily requires the melting and engaging step in order to provide the fused joint area 120.

In one preferred and non-limiting embodiment, the second end 110 of one or both of the bell portions 106 may be faced prior to the alignment step. Specifically, using a facing mechanism (as described in U.S. Pat. No. 6,982,051), and prior to melting and engaging the second ends 110 of the bell portions 106, this facing mechanism is used to ensure flush and opposing edges. In particular, the facing mechanism continues to grind or face the ends 110 until a minimal distance exists between faced ends 110 or the devices clamping or holding these ends 110.

Still further, and as discussed above in connection with the fusion of linear lengths of conduit 100, the melting step of the present embodiment may include the simultaneous heating of both the second end 110 of the bell portion 106 of the first conduit 116 and the second end 110 of the bell portion 106 of the second conduit 118. In order to effect appropriate heating and melting of the second ends 110, multiple heat zones can be provided and applied to the second ends 110 of the bell portions 106 of the conduits 116, 118. In particular, heating plates (as described in U.S. Pat. No. 6,982,051) may be used to provide such zone heating, e.g., variance in temperature of various portions of the heating surface, for example, the upper and lower surface. This provides a more uniform melting of the ends 110, due to the natural physics of the heating process.

After the conduits 116, 118, and in particular the bell portions 106 of the conduits 116, 118, are fused, an outer bead 122 and inner bead 124 are formed. Again, such beads 122, 124 are formed since the second end 110 of the bell portion 106 of each conduit 116, 118 is heated and at least partially melted. Upon engaging and pressing the ends 110 together, the melted material is pressed and deforms to create these beads 122, 124. See FIG. 3. It is the detrimental effects of these formed beads 122, 124 that the above-described conduit 100, 116, 118 and fusion method minimize or obviate, with particular usefulness in connection with conduit used to house wiring, cables, etc.

By using the above-discussed polyvinyl chloride composition, as well as the bell portions 106 of the conduit 100, a full strength fused joint area 120 is created. Due to the shape of the fused bell portions 106, the inner bead 124 that is formed during the fusion process does not encroach into the area defined by the linear portion inside diameter. Other dimensions may be modified and maximized for effective use and general flow characteristics. Such dimensions, e.g., bell portion 106 length and offset from the linear portion 102 of the conduit 100, are set to keep the inner bead 124 out of the area defined by the linear portion inside diameter 104, as well as to minimize the overall, fused bell portion 106 length. In particular, by minimizing the overall bell portion 106 length, the ability of wire or fiber optic cable to sag into the bell portion 106 (and jeopardize the integrity of its protective coating by touching or rubbing against the inner bead 124) is minimized or eliminated. Still further, the bell portion 106 length and offset may also be set to be utilized in various specialized applications.

As discussed, and in one preferred and non-limiting embodiment, the conduit 100, 116, 118 (or any part thereof) may be manufactured using a polyvinyl chloride composition. In manufacturing the conduit 100, a linear section 126 of conduit is provided, and this linear section 126 includes at least one terminal end 128. Next, the terminal end 128 is engaged with a shaped mandrel 130, which bears against the terminal end 128 and deforms the linear section 126, thereby forming the above-discussed bell portion 106 at the terminal end 128 of the linear section 126. Accordingly, the mandrel 130 is sized and shaped so as to impart the appropriate form, contour, shape and size of the desired bell portion 106 to the linear section 126 of the conduit 100.

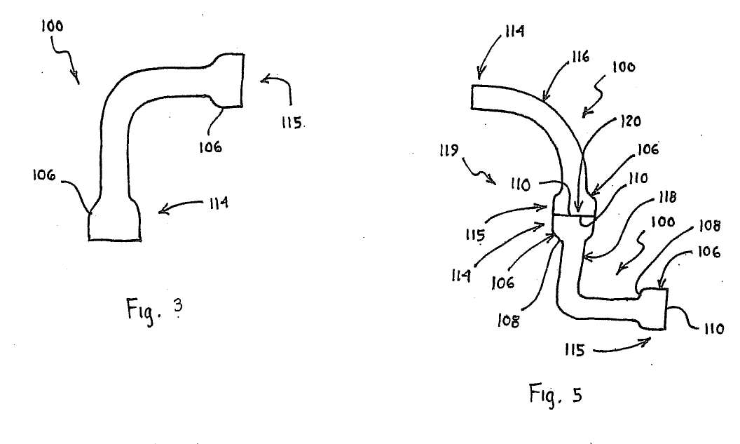

The present invention contemplates various ways of forming the bell portion 106. In one embodiment, and as illustrated in FIG. 4, prior to engaging the terminal end 128 against the shaped mandrel 130, the terminal end 128 is heated. Specifically, the terminal end 128 is heated to a temperature sufficient to allow the end 128 to form and take the shape of the shaped mandrel 130. In another embodiment, and as opposed to heating the terminal end 128 of the linear section 126, the shaped mandrel 130 is heated to a temperature appropriate to at least partially melt the terminal end 128 of the conduit 100. Such an arrangement is illustrated in FIG. 5. In order to allow the shaped mandrel 130 to achieve the desired melting temperature, an appropriate heat source 132 may be provided. Of course, this heat source 132 may be controlled to a specified temperature range in order to maximize the efficiency and effectiveness of the heating process.

After the bell portion 106 is formed at the terminal end 128 of the conduit 100, this newly-formed bell portion 106 is permitted to cool. After the bell portion 106 has cooled and cured, it is disengaged from the shaped mandrel 130. This same manufacturing technique may be used on each terminal end 128 of the linear section 126, as needed.

In one preferred and non-limiting embodiment, the bell portions 106 may be about 1.5 inches long from the first end 108 to the second end 110. Certain preferred, but non-limiting, inside and outside diameters of the bell portion 106 are as follows:

| Nominal Conduit Size | Bell Inside Diameter | Bell Outside Diameter |
|---|---|---|
| 3″ | 3.5756″ | 4.0002″ |
| 4″ | 4.5150″ | 4.9960″ |
| 5″ | 5.5136″ | 6.0472″ |
| 6″ | 6.5342″ | 7.1147″ |

While specific methods for manufacturing the inventive conduit 100 have been discussed, any manner of positioning or forming the bell portion 106 on the conduit 100 is envisioned. For example, as opposed to using the shaped mandrel 130, shaped sleeves, forms, molds and other arrangements may be used. For example, the bell portion 106 may be formed on the conduit 100 during the initial extrusion or molding process, or in a variety of methods known in the art for preparing and manufacturing shaped plastic products.

In another preferred and non-limiting embodiment, the bell portion 106 is formed on-site or in the field using transportable and/or portable (mobile) equipment. For example, a fusion apparatus, e.g., the apparatus described in U.S. Pat. No. 6,982,051 can be modified for use in forming the bell portion 106 on a linear length of extruded conduit 100. In addition, the shaped mandrel 130, e.g., in the form of a modified heater mechanism, heat plate, etc., may be used on or in connection with the fusion apparatus. Accordingly, the bell portion 106 can be formed on one or both ends of the conduit 100 on an “as-needed” basis in the field.

In this manner, this aspect of the present invention eliminates the potential impact of the inner bead 124 formed during the fusion process. In addition, this impact is minimized and eliminated without adding additional process steps, costs or manufacturing time to the fusion process. Still further, the bell portions 106 may be formed well prior to the installation process during the extrusion phase. In this manner, any fusion process that occurs at the work site is not altered, and the overall length of time to engage in the process is not lengthened. In addition, this aspect of the present invention removes the need for any de-beading equipment, and the fused joint area 120 does not exhibit the above-discussed drawbacks associated with mechanical joints.

This invention has been described with reference to the preferred embodiments. Obvious modifications and alterations will occur to others upon reading and understanding the preceding detailed description. It is intended that the invention be construed as including all such modifications and alterations.

What is claimed is:

1. A method for fusing a first conduit to a second conduit, wherein the first conduit and the second conduit each comprise a linear portion having a linear portion inside diameter; and at least one bell portion with a first end and a second end and having a bell portion inside diameter that increases from the first end to the second end, the method comprising:
(a) melting at least a portion of each of the second end of the bell portion of the first conduit and the second end of the bell portion of the second conduit; and
(b) engaging the melted second end of the bell portion of the first conduit with the melted second end of the bell portion of the second conduit, thereby creating a fused joint area.

2. The method of claim 1, further comprising maintaining pressure between the engaged second end of the bell portion of the first conduit and the second end of the bell portion of the second conduit until the melted ends of each conduit are cooled sufficiently to provide a fused joint area of a desired strength.

3. The method of claim 1, wherein, prior to step (a), the method further comprises aligning the second end of the bell portion of the first conduit with the second end of the bell portion of the second conduit.

4. The method of claim 1, wherein the first conduit, the second conduit, the linear portion of the first conduit, the linear portion of the second conduit, the bell portion of the first conduit, the bell portion of the second conduit or any combination thereof, are manufactured from a polyvinyl chloride composition, a thermoplastic material, polyethylene, HDPE or any combination thereof.

5. The method of claim 1, wherein the first conduit comprises a bell portion positioned on each end of the first conduit.

6. The method of claim 5, further comprising the steps of:
melting at least a portion of each of a second end of an un-fused bell portion of the first conduit and a second end of a bell portion of a subsequent conduit; and
engaging the melted second end of the un-fused bell portion of the first conduit with the melted second end of the bell portion of the subsequent conduit portion, thereby creating a subsequent fused joint area.

7. The method of claim 1, further comprising the step of facing at least one of the second end of the bell portion of the first conduit and the second conduit prior to the melting step.

8. The method of claim 1, wherein the melting step includes the simultaneous heating of both the second end of the bell portion of the first conduit and the second end of the bell portion of the second conduit.

9. The method of claim 1, further comprising the step of applying a plurality of heat zones to at least a portion of the second end of the bell portion of the first conduit, at least a portion of the second end of the bell portion of the second conduit or any combination thereof.

10. The method of claim 9, wherein at least one of the plurality of heat zones is configured to exhibit a different temperature than at least one other heat zone.

11. The method of claim 1, further comprising engaging a terminal end of a linear section of conduit with a shaped mandrel, thereby forming the bell portion of at least one of the first conduit and the second conduit.

12. The method of claim 11, wherein, prior to engaging the terminal end of the conduit with the shaped mandrel, the terminal end is heated.

13. The method of claim 11, wherein, prior to or during the engaging step, the shaped mandrel is heated to a temperature appropriate to at least partially melt the terminal end of the conduit.

14. The method of claim 11, further comprising:
cooling the formed bell portion of the conduit; and
disengaging the formed bell portion of the conduit from the shaped mandrel.

15. The method of claim 11, wherein the linear section of the first conduit or second conduit includes two terminal ends, wherein a bell portion is formed on each terminal end of the conduit.

16. The method of claim 11, wherein the conduit, the linear section, the bell portion or any combination thereof are extruded from a polyvinyl chloride composition.
